(19) United States
(12) Patent Application Publication
(10) Pub. No.: US 2017/0255622 A1
(43) Pub. Date: Sep. 7, 2017

(54) FILE RECONSTRUCTION DEVICE AND NON-TRANSITORY COMPUTER READABLE STORAGE MEDIUM

(71) Applicant: FUJI XEROX CO., LTD., Tokyo (JP)

(72) Inventors: Hirotaka ARAI, Kanagawa (JP); Satoshi KOJIMA, Kanagawa (JP); Morihiro KAMEDA, Kanagawa (JP); Yoshinori SATO, Kanagawa (JP)

(73) Assignee: FUJI XEROX CO., LTD., Tokyo (JP)

(21) Appl. No.: 15/208,676

(22) Filed: Jul. 13, 2016

(30) Foreign Application Priority Data
Mar. 3, 2016 (JP) 2016-041128

(51) Int. Cl. G06F 17/30; G06K 9/00; H04N 1/00

(52) U.S. Cl. CPC G06F 17/3012; H04N 1/00891; G06K 9/00456; G06F 17/30082; H04N 2201/0094

(57) ABSTRACT

A file reconstruction device includes an extraction unit and a creation unit. The extraction unit extracts pages conforming to a predetermined condition, from an input file including plural pages. The creation unit creates an output file including the two or more conforming pages extracted from the input file by the extraction unit.

### CROSS-REFERENCE TO RELATED APPLICATIONS

This application is based on and claims priority under 35 USC 119 from Japanese Patent Application No. 2016-041128 filed Mar. 3, 2016.

### BACKGROUND

### Technical Field

The present invention relates to a file reconstruction device and a non-transitory computer readable storage medium.

### SUMMARY

According to an aspect of the invention, a file reconstruction device includes an extraction unit and a creation unit. The extraction unit extracts pages conforming to a predetermined condition, from an input file including plural pages. The creation unit creates an output file including the two or more conforming pages extracted from the input file by the extraction unit.

### BRIEF DESCRIPTION OF THE DRAWINGS

Exemplary embodiments of the present invention will be described in detail based on the following figures, wherein:

FIG. 1 is a diagram showing an example of a configuration of an image data classifying system of this exemplary embodiment;

FIG. 2 is a block diagram showing a configuration of a control unit provided in an image forming apparatus;

FIG. 3 is a diagram showing an outline of a rule table;

FIG. 4 is a block diagram showing a configuration of an image storage unit provided in a server apparatus;

FIGS. 5A to 5E are diagrams showing examples of input files;

FIG. 6 is a flow chart showing a procedure of an extraction and combination classifying process;

FIG. 7 is a diagram showing a first specific example regarding an extraction and combination classifying process;

FIG. 8 is a diagram showing a second specific example regarding an extraction and combination classifying process;

FIG. 9 is a diagram showing a third specific example regarding an extraction and combination classifying process;

FIG. 10 is a flow chart showing a procedure of a continuous combination classifying process;

FIG. 11 is a flow chart showing a procedure of a temporary storage region output process (subroutine) shown in FIG. 10;

FIG. 12 is a diagram showing a first specific example regarding a continuous combination classifying process; and

FIG. 13 is a diagram showing a second specific example regarding a continuous combination classifying process.

### DETAILED DESCRIPTION

Hereinafter, an exemplary embodiment of the invention will be described in detail with reference to the accompanying drawings.

Configuration of Image Data Classifying System

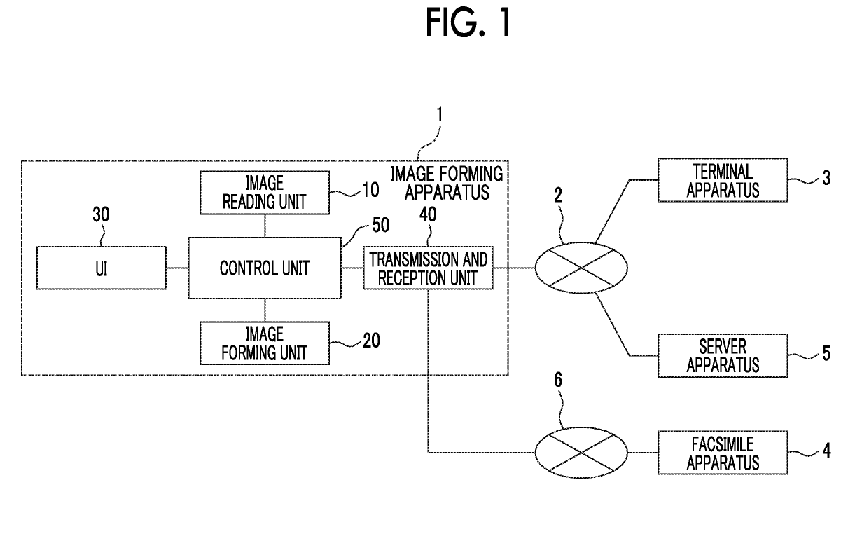

FIG. 1 is a diagram showing an example of a configuration of an image data classifying system of this exemplary embodiment.

The image data classifying system includes an image forming apparatus 1 having a scanning function, a printing function, a copying function, and a facsimile function to operate as a so-called multifunction machine, a network 2 and a telephone line 6 that are connected to the image forming apparatus 1, a terminal apparatus 3 and a server apparatus 5 that are connected to the network 2, and a facsimile apparatus 4 which is connected to the telephone line 6.

Here, the network 2 includes an Internet line or the like. In addition, the terminal apparatus 3 transmits and receives various pieces of data (image data is included) to and from the image forming apparatus 1 through the network 2, and includes, for example, a personal computer (PC). Further, the facsimile apparatus 4 transmits and receives a facsimile to and from the image forming apparatus 1 through the telephone line 6. Further, the server apparatus 5 transmits and receives various pieces of data (image data and programs are included) to and from the image forming apparatus 1 through the network 2.

In addition, the image forming apparatus 1 includes an image reading unit 10 that reads an image which is recorded in a recording medium such as paper, an image forming unit 20 that forms an image on a recording medium such as paper, a user interface (UI) 30 that receives a user's instruction related to an operation using the turn-on or turn-off of a power supply, a scanning function, a printing function, a copying function, and a facsimile function and displays a message to the user, a transmission and reception unit 40 that transmits and receives data to and from the terminal apparatus 3 and the server apparatus 5 through the network 2 and transmits and receives data to and from the facsimile apparatus 4 through the telephone line 6, and a control unit 50 that controls operations of the image reading unit 10, the image forming unit 20, the UI 30, and the transmission and reception unit 40.

Operation of Image Data Classifying System

Here, an outline of a classifying process performed by the image data classifying system shown in FIG. 1 will be briefly described.

First, the control unit 50 provided in the image forming apparatus 1 acquires one input file from the outside of the control unit 50. Here, the input file is configured to include one or more pages. In addition, examples of the input file include an input file which is transmitted from the terminal apparatus 3 other than its own apparatus through the network 2 and the transmission and reception unit 40, an input file which is transmitted from the facsimile apparatus 4 other than its own apparatus through the telephone line 6 and the transmission and reception unit 40, an input file which is obtained by reading an original document by the image reading unit 10 within its own apparatus, and the like.

Next, the control unit 50 analyzes one input file, which is acquired from the outside, in page units. Subsequently, the control unit 50 classifies pages based on analysis results of the pages constituting the input file to perform reconstruction to one or more output files. In addition, the control unit 50 outputs one or more output files obtained by reconstructing one input file toward the server apparatus 5 other than its own apparatus.

The output files that are output from the control unit 50 are transmitted to the server apparatus 5 through the transmission and reception unit 40 and the network 2. In addition, the server apparatus 5 stores the received output files.

Configuration of Control Unit Provided in Image Forming Apparatus

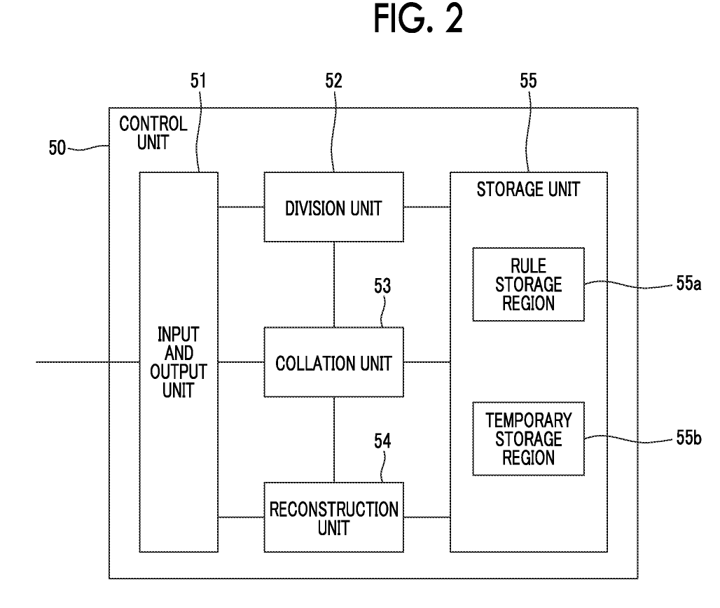

FIG. 2 is a block diagram showing a configuration of the control unit 50 provided in the image forming apparatus 1.

Meanwhile, FIG. 2 shows only functional blocks related to an image data classifying process which is performed by the image data classifying system shown in FIG. 1, and functional blocks related to the control of operations of the image reading unit 10 and the like will not be described.

The control unit 50 includes a central processing unit (CPU) that reads out and executes a program, a read only memory (ROM) that stores a program executed by the CPU, data which is used at the time of executing the program, and the like, a random access memory (RAM) that stores data temporarily generated at the time of executing the program, and the like, and an electrically erasable programmable read-only memory (EEPROM) that stores data used at the time of executing the program, and the like, is capable of rewriting the contents thereof, and is capable of holding the stored contents even when a power supply is not supplied thereto (all of which are not shown in the drawing). Here, the program executed by the CPU, which is provided in the control unit 50, can also be provided to the CPU in a state of being stored in a storage medium such as a CD-ROM or can also be provided to the CPU through the network 2, in addition to being stored in a ROM or an EEPROM in advance.

The control unit 50 includes an input and output unit 51, a division unit 52, a collation unit 53, a reconstruction unit 54, and a storage unit 55. In addition, the storage unit 55 includes a rule storage region 55a and a temporary storage region 55b.

The input and output unit 51 inputs and outputs various pieces of data (the above-mentioned input file and output file are included) to and from the control unit 50, the image reading unit 10, the image forming unit 20, the UI 30, and the transmission and reception unit 40.

In a case where an input file which is input from the input and output unit 51 includes plural pages, the division unit 52 divides the input file into page units. Meanwhile, in the following description, image data of the pages constituting the input file will be referred to as “target image data”.

The collation unit 53 collates target image data which is input from the division unit 52 with reference image data which is registered in a rule table stored in the rule storage region 55a of the storage unit 55. Various known methods may be applied as a collation method adopted in the collation unit 53. In addition, the collation unit 53 stores target image data of a specific page in the temporary storage region 55b of the storage unit 55 when necessary based on a result of the collation between the target image data and the reference image data. Meanwhile, the rule table and the reference image data will be described later in detail.

The reconstruction unit 54 reconstructs the above-mentioned input file to one or more output files each of which includes one or more pages, based on the result of the collation between the target image data and the reference image data which is performed by the collation unit 53.

In the storage unit 55, the rule storage region 55a stores the above-mentioned rule table, and the temporary storage region 55b stores target image data of a specific page. Here, the rule storage region 55a may include an EEPROM or the like, and the temporary storage region 55b may include a RAM or the like.

Here, in this exemplary embodiment, the control unit 50 is an example of a file reconstruction device. In addition, the division unit 52, the collation unit 53, the reconstruction unit 54, and the storage unit 55 are examples of an extraction unit and a creation unit. Further, the collation unit 53 is an example of a collation unit.

Outline of Rule Table

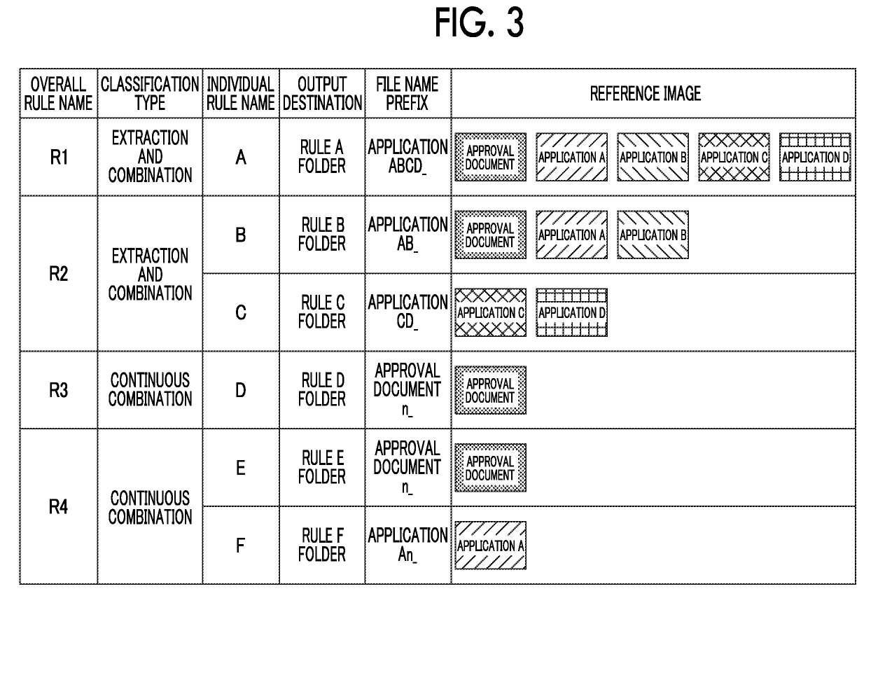

FIG. 3 is a diagram showing an outline of a rule table which is used as a classification rule in an image data classifying process. The rule table is stored in the rule storage region 55a of the storage unit 55 shown in FIG. 2.

In the rule table of this exemplary embodiment, overall rule names given to respective general rules (referred to as overall rules), classification types which are set with respect to the respective overall rules, individual rule names given to one or more rules (referred to as individual rules) which are set among the overall rules, output destinations which are set in the respective individual rules, file name prefixes, and reference images are associated with each other. Here, in the example shown in FIG. 3, four overall rules (first overall rule R1 to fourth overall rule R4) are registered in the rule table.

In the rule table shown in FIG. 3, the classification type indicates a type of image data classifying process, and extraction and combination (classifying process) or continuous combination (classifying process) is set thereto. Here, an “extraction and combination classifying process” refers to a process of extracting a page (collation success page) having succeeded in collation with a slip (reference image data) from one or more pages (target image data) which constitute an input file and combining the extracted one or more collation success pages with each other to thereby configure a bundle of output files. In addition, a “continuous combination classifying process” refers to a process of extracting a page (collation success page) having succeeded in collation with a slip (reference image data) and a page (collation failure page) which is continuous with the collation success page and has failed in collation with a slip (reference image data) and combining the extracted one or more collation success pages and one or more collation failure pages, which are continuous with the collation success pages, with each other to thereby configure a bundle of output files. Meanwhile, the “extraction and combination classifying process” and the “continuous combination classifying process” will be described later in detail.

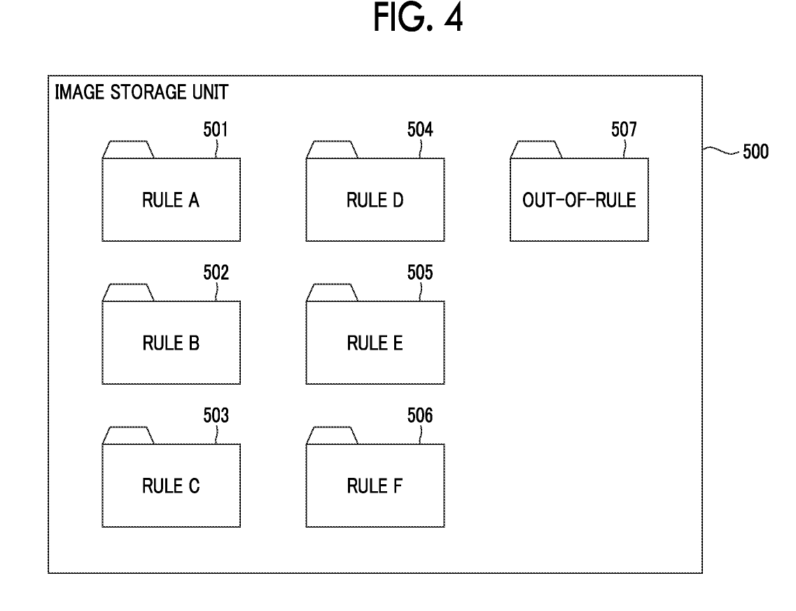

In addition, the output destination in the individual rule is set to be a folder name for storing an output file which conforms to the individual rule. Meanwhile, in this example, all of the output destinations are set to be folders provided in an image storage unit 500 (see FIG. 4 to be described later) of the server apparatus 5.

Further, the file name prefix in the individual rule is set to be a name which is given to the head of a file name of an output file which conforms to the individual rule. Meanwhile, in this example, all of the file name prefixes are determined from names of pieces of reference image data to be described later.

Further, the reference image in the individual rule includes one or more pieces of reference image data. Here, an “approval document”, an “application A”, an “application B”, an “application C”, and an “application D” in the reference images described in FIG. 3 will be described before the four overall rules are individually described.

First, the “approval document” is a document for so-called approval, and is formed in a specific form. In addition, the “application A” is, for example, a document for making a request with respect to a contract A, and is formed in a specific form different from the “approval document”. Further, an “application B” is, for example, a document for making a request with respect to a contract B, and is formed in a specific form different from the “approval document” and the “application A”. Further, an “application C” is, for example, a document for making a request with respect to a contract C, and is formed in a specific form different from the “approval document”, the “application A”, and the “application B”. In addition, an “application D” is, for example, a document for making a request with respect to a contract D, and is formed in a specific form different from the “approval document”, the “application A”, the “application B”, and the “application C”. Hereinafter, a document (an electronic document is included) is formed in a specific form like the “approval document”, the “application A”, the “application B”, the “application C”, and the “application D”, and a document (an electronic document is included) which is registered as a reference image in the rule table will be referred to as a “slip”.

Meanwhile, contents of the overall rule are set and registered by a user. That is, setting, related to the overall rule (individual rule is included), which is received from the UI 30 provided in the image forming apparatus 1, the terminal apparatus 3 connected to the image forming apparatus 1 through the network 2, or the like is registered in the rule storage region 55a of the storage unit 55 in the control unit 50. In addition, in this example, any one of the plural overall rules stored in the rule storage region 55a is selected and is set in the control unit 50.

Then, contents of each of the first to the fourth overall rules R1 to R4 will be described in detail with reference to FIG. 3.

In the first overall rule R1, a classification type is set to “extraction combination”, and an individual rule is set to one (individual rule name: an individual rule A). Here, in the individual rule A, an output destination is set to a “rule A folder”, and a file name prefix is set to an “application ABCD_”. In addition, in the individual rule A, reference images are set to an “approval document”, an “application A”, an “application B”, an “application C”, and an “application D”.

In the second overall rule R2, a classification type is set to “extraction combination”, and an individual rule is set to two (individual rule name: an individual rule B and an individual rule C). Here, in the individual rule B, an output destination is set to a “rule B folder”, and a file name prefix is set to an “application AB_”. In addition, in the individual rule B, reference images are set to an “approval document”, an “application A”, and an “application B”. On the other hand, in the individual rule C, an output destination is set to a “rule C folder”, and a file name prefix is set to an “application CD_”. In addition, in the individual rule C, reference images are set to an “application C” and an “application D”. In addition, in the individual rule C and the individual rule D that are included in the second overall rule R2, contents of the individual rules (the output destination, the file name prefix, and the reference image) do not overlap each other.

In the third overall rule R3, a classification type is set to “continuous combination”, and an individual rule is set to one (individual rule name: an individual rule D). Here, in the individual rule D, an output destination is set to a “rule D folder”, and a file name prefix is set to an “approval document n_” (here, n is an ordinal number). In addition, in the individual rule D, a reference image is set to an “approval document”.

In the fourth overall rule R4, a classification type is set to “continuous combination”, and an individual rule is set to two (individual rule name: an individual rule E and an individual rule F). Here, in the individual rule E, an output destination is set to a “rule E folder”, and a file name prefix is set to an “approval document n_” (here, n is an ordinal number). In addition, in the individual rule E, a reference image is set to an “approval document”. On the other hand, in the individual rule F, an output destination is set to a “rule F folder”, and a file name prefix is set to an “application An_” (here, n is an ordinal number). In addition, in the individual rule F, a reference image is set to an “application A”. In addition, in the individual rule E and the individual rule F that are included in the fourth overall rule R4, contents of the individual rules (the output destination, the file name prefix, and the reference image) do not overlap each other.

In this manner, in the example shown in FIG. 3, the classification types of the first overall rule R1 and the second overall rule R2 are set to “extraction combination”, while the classification types of the third overall rule R3 and the fourth overall rule R4 are set to “continuous combination”. In addition, in the first overall rule R1 and the second overall rule R2 of which the classification types are set to “extraction combination”, the number of individual rules that are set in the first overall rule R1 is one (single), while the number of individual rules that are set in the second overall rule R2 is two (plural). On the other hand, also in the third overall rule R3 and the fourth overall rule R4 of which the classification types are set to “continuous combination”, the number of individual rules that are set in the third overall rule R3 is one (single), while the number of individual rules that are set in the fourth overall rule R4 is two (plural).

Here, in this exemplary embodiment, two of plural reference images that are set in individual rules constituting the first overall rule R1 and the second overall rule R2 function as a first reference image and a second reference image. In addition, in this exemplary embodiment, reference images that are respectively set in plural individual rules constituting the second overall rule R2 and the fourth overall rule R4 function as one reference image (first condition) and the other reference image (second condition).

Configuration of Image Storage Unit Provided in Server Apparatus

FIG. 4 is a diagram showing a configuration of the image storage unit 500 provided in the server apparatus 5 shown in FIG. 1.

The image storage unit 500 includes an auxiliary storage device such as a hard disk drive (HDD) or a solid state drive (SSD). In this example, a rule A folder 501, a rule B folder 502, a rule C folder 503, a rule D folder 504, a rule E folder 505, a rule F folder 506, and an out-of-rule folder 507 are provided in a storage region of the image storage unit 500.

The rule A folder 501 corresponds to the output destination of the individual rule A shown in FIG. 3, and stores an output file including image data that satisfies the individual rule A. The rule B folder 502 corresponds to the output destination of the individual rule B shown in FIG. 3, and stores an output file including image data that satisfies the individual rule B. The rule C folder 503 corresponds to the output destination of the individual rule C shown in FIG. 3, and stores an output file including image data that satisfies the individual rule C. The rule D folder 504 corresponds to the output destination of the individual rule D shown in FIG. 3, and stores an output file including image data that satisfies the individual rule D. The rule E folder 505 corresponds to the output destination of the individual rule E shown in FIG. 3, and stores an output file including image data that satisfies the individual rule E. The rule F folder 506 corresponds to the output destination of the individual rule F shown in FIG. 3, and stores an output file including image data that satisfies the individual rule F. The out-of-rule folder 507 stores an output file including image data that does not satisfy an individual rule which is set in each overall rule. Specifically, the out-of-rule folder 507 stores an output file including image data that does not satisfy the individual rule A, for example, in a case where the first overall rule R1 is set, and stores an output file including image data that does not satisfy the individual rule B and the individual rule C, for example, in a case where the second overall rule R2 is set.

Input File

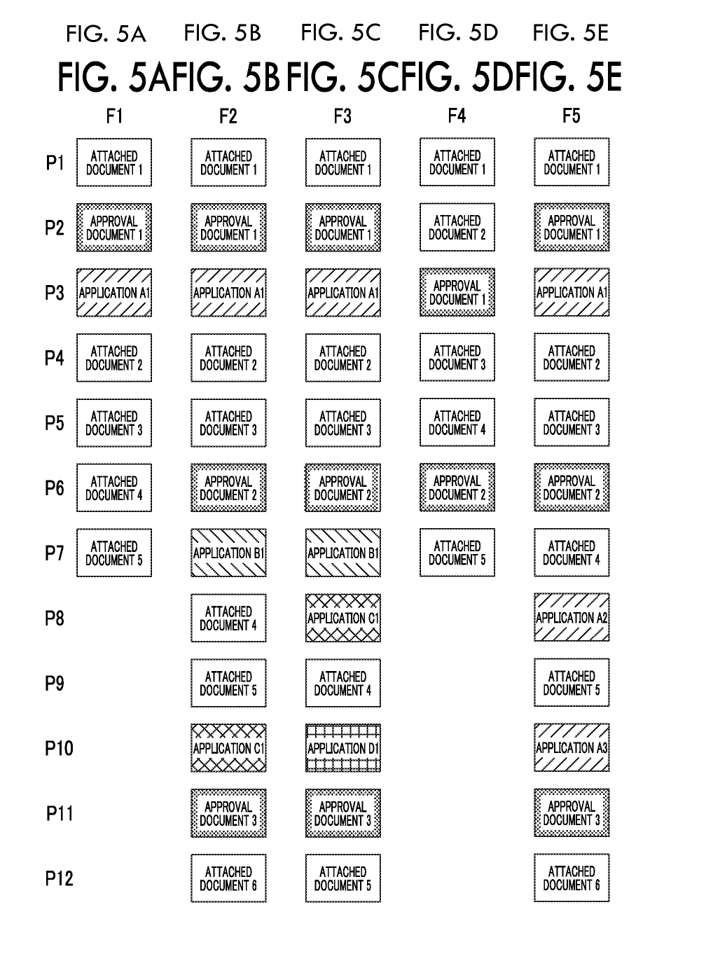

FIGS. 5A to 5E are diagrams showing examples of input files used in this exemplary embodiment. Here, FIG. 5A illustrates a first input file F1, FIG. 5B illustrates a second input file F2, FIG. 5C illustrates a third input file F3, FIG. 5D illustrates a fourth input file F4, and FIG. 5E illustrates a fifth input file F5. Meanwhile, the first input file F1 to the fifth input file F5 are used in a specific example to be described later.

Here, an “approval document m”, an “application Am”, an “application Bm”, an “application Cm”, an “application Dm”, and an “attached document m” (here, m is an ordinal number) that are shown in FIGS. 5A to 5E will be described before FIGS. 5A to 5E are individually described.

First, the “approval document m” means a document in which, for example, handwritten characters and the like are written in a form of the “approval document” shown in FIG. 3. In addition, the “application Am” means an application in which, for example, handwritten characters and the like are written in a form of the “application A” shown in FIG. 3. Further, the “application Bm” means an application in which, for example, handwritten characters and the like are written in a form of the “application B” shown in FIG. 3. Further, the “application Cm” means an application in which, for example, handwritten characters and the like are written in a form of the “application C” shown in FIG. 3. In addition, the “application Dm” means an application in which, for example, handwritten characters and the like are written in a form of the “application D” shown in FIG. 3. In addition, the “attached document m” indicates something other than the above-mentioned various slips (the “approval document”, the “application A”, the “application B”, the “application C”, and the “application D”).

The first input file F1 shown in FIG. 5A includes pieces of target image data for seven pages. Here, among the pieces of target image data for seven pages, a second page (P2) and a third page (P3) are slips, and the remaining pages (P1, P4 to P7: for five pages) are attached documents (attached documents 1 to 5). In addition, among the slips of the two pages, the second page (P2) is an approval document 1 (first) corresponding to an “approval document” of a reference image, and the third page (P3) is an application A1 (first) corresponding to an “application A” of a reference image. In this manner, the first input file F1 includes an “approval document” for one page and an “application A” for one page, as slips.

The second input file F2 shown in FIG. 5B includes pieces of target image data for twelve pages. Here, among the pieces of target image data for twelve pages, a second page (P2), a third page (P3), a sixth page (P6), a seventh page (P7), a tenth page (P10), and an eleventh page (P11) are slips, and the remaining pages (P1, P4, P5, P8, P9, P12: for six pages) are attached documents (attached documents 1 to 6). In addition, among the slips of the six pages, the second page (P2) is an approval document 1 (first) corresponding to an “approval document” of a reference image, and the third page (P3) is an application A1 (first) corresponding to an “application A” of a reference image. In addition, the sixth page (P6) is an approval document 2 (second) corresponding to an “approval document” of a reference image, and the seventh page (P7) is an application B1 (first) corresponding to an “application B” of a reference image. Further, the tenth page (P10) is an application C1 (first) corresponding to an “application C” of a reference image, and the eleventh page (P11) is an approval document 3 (third) corresponding to an “approval document” of a reference image. In this manner, the second input file F2 includes “approval documents” for three pages, an “application A” for one page, an “application B” for one page, and an “application C” for one page.

The third input file F3 shown in FIG. 5C includes pieces of target image data for twelve pages. Here, among the pieces of target image data for twelve pages, a second page (P2), a third page (P3), a sixth page (P6), a seventh page (P7), an eighth page (P8), a tenth page (P10), and an eleventh page (P11) are slips, and the remaining pages (P1, P4, P5, P9, P12: for five pages) are attached documents (attached documents 1 to 5). In addition, among the slips of the seven pages, the second page (P2) is an approval document 1 (first) corresponding to an “approval document” of a reference image, and the third page (P3) is an application A1 (first) corresponding to an “application A” of a reference image. In addition, the sixth page (P6) is an approval document 2 (second) corresponding to an “approval document” of a reference image, and the seventh page (P7) is an application B1 (first) corresponding to an “application B” of a reference image. Further, the eighth page (P8) is an application C1 (first) corresponding to an “application C” of a reference image, and the tenth page (P10) is an application D1 (first) corresponding to an “application D” of a reference image. Further, the eleventh page (P11) is an approval document 3 (third) corresponding to an “approval document” of a reference image. In this manner, the third input file F3 includes “approval documents” for three pages, an “application A” for one page, an “application B” for one page, an “application C” for one page, and an “application D” for one page, as slips.

The fourth input file F4 shown in FIG. 5D includes pieces of target image data for seven pages. Here, among the pieces of target image data for seven pages, a third page (P3) and a sixth page (P6) are slips, and the remaining pages (P1, P2, P4, P5, P7: for five pages) are attached documents (attached documents 1 to 5). In addition, among the slips of the two pages, the third page (P3) is an approval document 1 (first) corresponding to an “approval document” of a reference image, and the sixth page (P3) is an approval document 2 (second) corresponding to an “approval document” of a reference image. In this manner, the fourth input file F4 includes “approval documents” for two pages, as slips.

The fifth input file F5 shown in FIG. 5E includes pieces of target image data for twelve pages. Here, among the pieces of target image data for twelve pages, a second page (P2), a third page (P3), a sixth page (P6), an eighth page (P8), a tenth page (P10), and an eleventh page (P11) are slips, and the remaining pages (P1, P4, P5, P7, P9, P12: for six pages) are attached documents (attached documents 1 to 6). In addition, among the slips of the six pages, the second page (P2) is an approval document 1 (first) corresponding to an “approval document” of a reference image, and the third page (P3) is an application A1 (first) corresponding to an “application A” of a reference image. In addition, the sixth page (P6) is an approval document 2 (second) corresponding to an “approval document” of a reference image, and the eighth page (P8) is an application A2 (second) corresponding to an “application A” of a reference image. Further, the tenth page (P10) is an application A3 (third) corresponding to an “application A” of a reference image, and the eleventh page (P11) is an approval document 3 (third) corresponding to an “approval document” of a reference image. In this manner, the fifth input file F5 includes “approval documents” for three pages and “applications A” for three pages, as slips.

Meanwhile, although five examples have been described as input files here, a configuration of the input file is not limited thereto, and the number of pages is not limited to seven or twelve. In addition, although a case where an input file includes plural pages has been described as an example here, the input file may include a single page. Further, although a description has been given here on the assumption that an input file includes slips and attached documents, the input file may include only slips or only attached documents.

Classifying Process in Image Data Classifying System

Then, a classifying process in the image data classifying system of this exemplary embodiment will be described in more detail. Meanwhile, here, an “extraction and combination classifying process” will be described first, and then a “continuous combination classifying process” will be described.

Procedure of Extraction and Combination Classifying Process

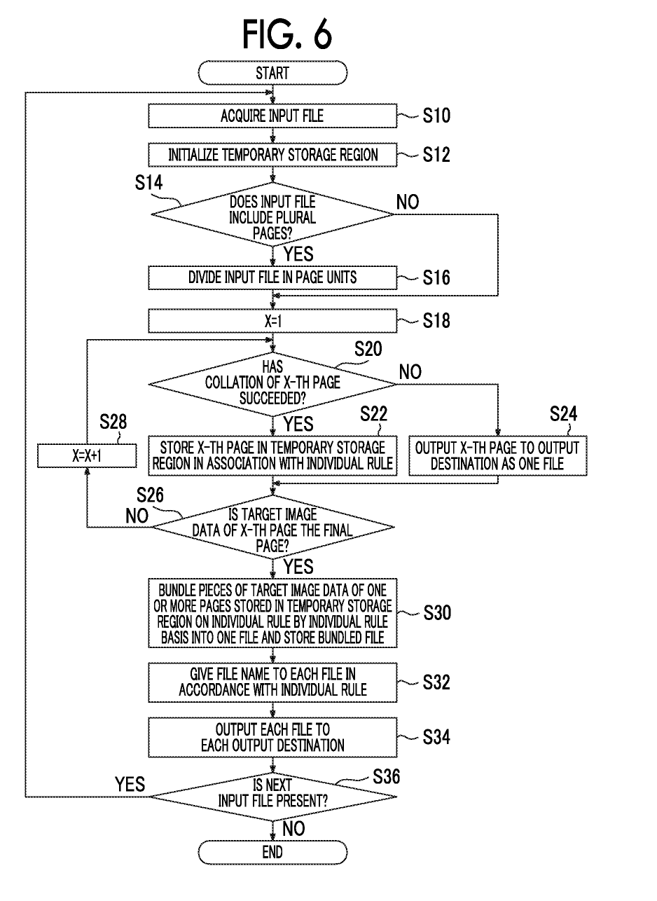

FIG. 6 is a flow chart showing a procedure of an extraction and combination classifying process.

In this exemplary embodiment, a process shown in FIG. 6 is performed by the control unit 50 (CPU) provided in the image forming apparatus 1. Meanwhile, here, in the control unit 50 of the image forming apparatus 1, it is assumed that an overall rule (first overall rule R1 or second overall rule R2 shown in FIG. 3) which includes the execution of an extraction and combination classifying process is read out from the rule storage region 55a of the storage unit 55 in advance and is set.

In this process, first, the division unit 52 acquires an input file through the input and output unit 51 (step 10). Then, the division unit 52 initializes the temporary storage region 55b which is provided in the storage unit 55 (step 12).

Next, the division unit 52 determines whether or not an input file acquired in step 10 includes plural pages (step 14). In a case where a determination result in step 14 is affirmative (YES), the division unit 52 divides the input file in page units (step 16), and outputs the divided input file to the collation unit 53, and the process proceeds to the next step 18. On the other hand, in a case where a determination result in step 14 is negative (NO), the division unit 52 outputs the input file to the collation unit 53 as it is without performing division, and the process proceeds to the next step 18.

Subsequently, the collation unit 53 sets a page number X to 1 (step 18) and collates target image data of an X-th page in the input file with one or more pieces of reference image data associated with an overall rule. In addition, it is determined whether or not the collation of the X-th page has succeeded (whether or not reference images having the same target image and form of the X-th page are present in the input file) (step 20).

In a case where a determination result in step 20 is affirmative (YES) (in a case where the X-th page is a conforming page), the collation unit 53 stores the target image data of the X-th page in the temporary storage region 55b of the storage unit 55 in association with an individual rule (step 22), and the process proceeds to the next step 26. On the other hand, in a case where a determination result in step 20 is negative (NO) (in a case where the X-th page is a non-conforming page), the collation unit 53 outputs the target image data of the X-th page to the reconstruction unit 54. The reconstruction unit 54 reconstructs the target image data of the X-th page as one file, and outputs the reconstructed target image data to an output destination associated with an individual rule (step 24), and the process proceeds to the next step 26. Meanwhile, in step 24, the reconstruction unit 54 outputs the obtained file to the outside (here, the transmission and reception unit 40) through the input and output unit 51, as an output file. In addition, the output file is transmitted to the server apparatus 5 through the network 2, and is stored in the out-of-rule folder 507 which is provided in the image storage unit 500 of the server apparatus 5.

Subsequently, the collation unit 53 determines whether or not the target image data of the X-th page is the final page in the input file (step 26). In a case where a determination result in step 26 is negative (NO), the collation unit 53 updates a page number to X=X+1 (step 28), and returns to step 20 to continue a process related to target image data of the next page.

On the other hand, in a case where a determination result in step 26 is affirmative (YES), the reconstruction unit 54 bundles pieces of target image data of one or more pages stored in the temporary storage region 55b of the storage unit 55 into one file on an individual rule by individual rule basis and stores the bundled file (step 30). Here, in step 30, there is the possibility that the same number of files (for example, one file in a case where the number of individual rules is one, or two files in a case where the number of individual rules is two) as the number of individual rules associated with an overall rule are created. In addition, in step 30, in a case where pieces of target image data for only one page are stored in the temporary storage region 55b, a file including the pieces of target image data for one page is created.

Then, the reconstruction unit 54 gives a file name, obtained by adding a file name prefix associated with an individual rule to a file name of the original input file of each file, to each file created in step 30 (step 32).

In addition, the reconstruction unit 54 outputs each file given the file name in step 32 to the outside (here, the transmission and reception unit 40) through the input and output unit 51, as an output file (step 34). In addition, the output file is transmitted to the server apparatus 5 through the network 2, and is stored in a folder (in this example, any one of the rule A folder 501 to the rule C folder 503 in a case of an extraction and combination classifying process) other than the out-of-rule folder 507 which is provided in the image storage unit 500 of the server apparatus 5.

Thereafter, the division unit 52 determines whether or not the next input file is present (step 36). In a case where a determination result in step 36 is affirmative (YES), the division unit 52 returns to step 10 to continue a process with respect to the next input file. On the other hand, in a case where a determination result in step 36 is negative (NO), the process is terminated.

### Specific Example Regarding Extraction and Combination Classifying Process

Then, the above-described extraction and combination classifying process will be described with reference to three specific examples.

### First Specific Example

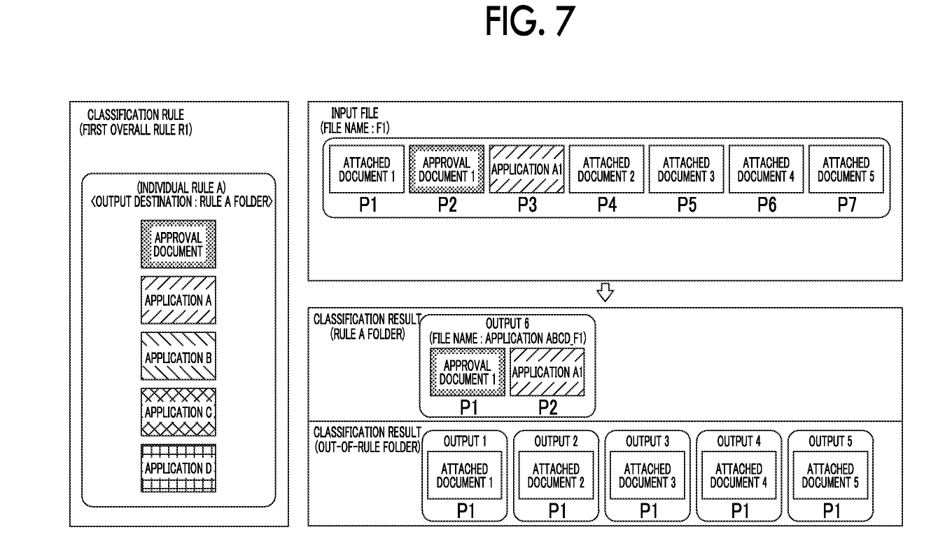

FIG. 7 is a diagram showing a first specific example regarding the extraction and combination classifying process.

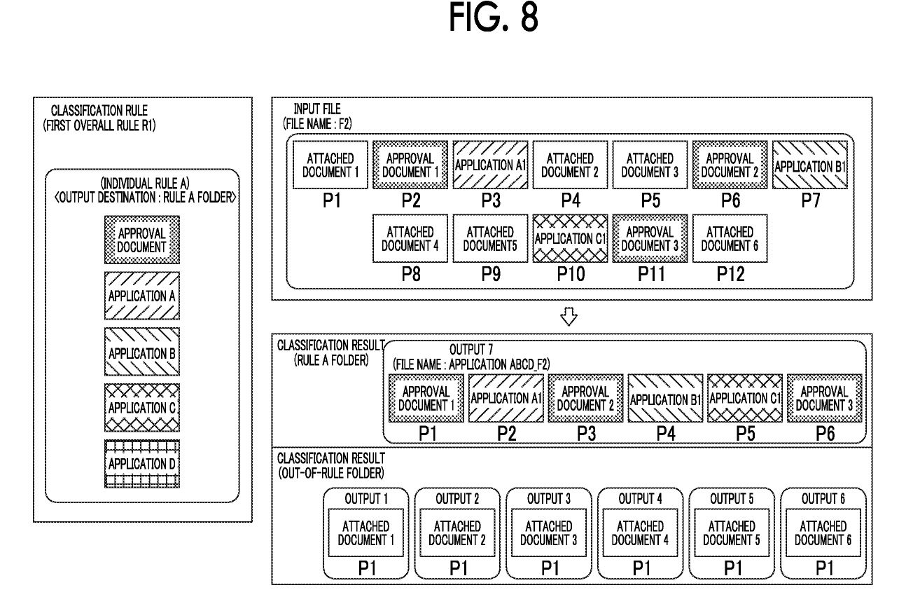

Here, a classification rule used in this example is shown on the left side of the drawing. In addition, an input file used in this example is shown on the upper right side of the drawing. Further, a classification result in this example is shown on the lower right side of the drawing. Meanwhile, the relationship therebetween is the same as those in FIGS. 8, 9, 12, and 13 to be described later.

In the first specific example, the classification rule is a first overall rule R1. Accordingly, an individual rule to be set is only an individual rule A, an output destination is set to a “rule A folder”, and reference images are set to an “approval document”, an “application A”, an “application B”, an “application C”, and an “application D”.

In addition, in the first specific example, an input file is the first input file F1. The first input file F1 includes pieces of target image data of a total of seven pages including slips (approval document 1 and application A1) of two pages (also see FIG. 5A).

Then, a description will be given of a classification result in a case where a process is performed on the first input file F1 in a state where the first overall rule R1 is set, according to the flow chart shown in FIG. 6.

In this case, an attached document 1 of a first page (P1) and attached documents 2 to 5 of fourth to seventh pages (P4) to (P7), which are not slips, are determined to be negative (NO) in step 20, and thus the attached documents are sequentially output as individual output files in step 24. However, the five output files (an output 1 to an output 5) do not include a slip, and thus the output destinations thereof are not set to the rule A folder 501 which is set in the individual rule A, but are set to the out-of-rule folder 507. In addition, the five output files (the output 1 to the output 5) are stored in the out-of-rule folder 507 which is provided in the image storage unit 500 of the server apparatus 5.

On the other hand, an approval document 1 of a second page (P2) and an application A1 of a third page (P3), which are slips, are determined to be affirmative (YES) in step 20, and thus the approval document and the application are stored in the temporary storage region 55b in a state of being associated with the individual rule A in step 22. In addition, when a determination result in step 26 is affirmative (YES) in accordance with the execution of collation of the seventh page (P7) which is the final page, the two pages associated with the individual rule A are bundled into one file in step 30, and then a file name “application ABCD_F1” having a file name prefix “application ABCD_”, associated with the individual rule A, added thereto is given to the original input file name (here, referred to as “F1”) in step 32. Then, an output file (output 6) given the file name “application ABCD_F1” is output using the rule A folder 501, which is set in the individual rule A, as an output destination in step 34. Thereafter, the output file (output 6) is stored in the rule A folder 501 which is provided in the image storage unit 500 of the server apparatus 5.

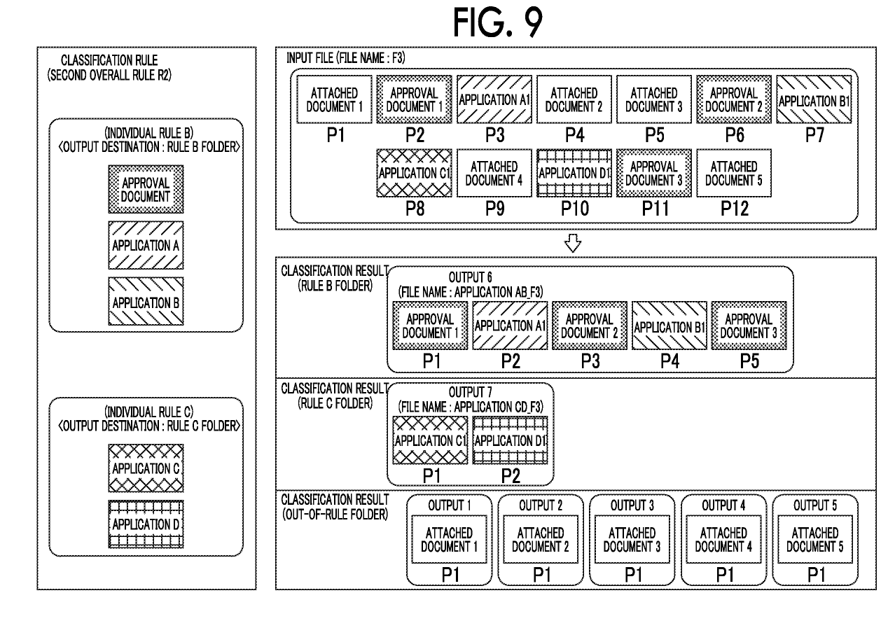

Meanwhile, when one file is created by bundling plural pages in step 30, the order of pages in a new file (output file) may match to the order of pages in the original input file (page numbers in the input file may be aligned in ascending order). Meanwhile, this is the same as in a second specific example shown in FIG. 8 and a third specific example shown in FIG. 9 to be described later.

### Second Specific Example

FIG. 8 is a diagram showing a second specific example regarding the extraction and combination classifying process.

In the second specific example, a classification rule is a first overall rule R1 similar to the first specific example described above. Accordingly, an individual rule to be set is only an individual rule A, an output destination is set to a “rule A folder”, and reference images are set to an “approval document”, an “application A”, an “application B”, an “application C”, and an “application D”.

In addition, in the second specific example, an input file is the second input file F2. The second input file F2 includes pieces of target image data of a total of twelve pages including slips of six pages (an approval document 1, an application A1, an approval document 2, an application B1, an application C1, and an approval document 3) (also see FIG. 5B).

In this manner, the first specific example and the second specific example are the same as each other in terms of a classification rule and are different from each other in contents of input files to be processed.

Then, a description will be given of a classification result in a case where a process is performed on the second input file F2 in a state where the first overall rule R1 is set, according to the flow chart shown in FIG. 6.

In this case, an attached document 1 of a first page (P1), an attached document 2 of a fourth page (P4), an attached document 3 of a fifth page (P5), an attached document 4 of an eighth page (P8), an attached document 5 of a ninth page (P9), and an attached document 6 of a twelfth page (P12), which are not slips, are determined to be negative (NO) in step 20, and thus the attached documents are sequentially output as individual output files in step 24. However, the six output files (an output 1 to an output 6) do not include a slip, and thus the output destinations thereof are not set to the rule A folder 501 which is set in the individual rule A, but are set to the out-of-rule folder 507. In addition, the six output files (the output 1 to the output 6) are stored in the out-of-rule folder 507 which is provided in the image storage unit 500 of the server apparatus 5.

On the other hand, an approval document 1 of a second page (P2), an application A1 of a third page (P3), an approval document 2 of a sixth page (P6), an application B1 of a seventh page (P7), an application C1 of a tenth page (P10), and an approval document 3 of an eleventh page (P11), which are slips, are determined to be affirmative (YES) in step 20, and thus the approval documents and the applications are stored in the temporary storage region 55b in a state of being associated with the individual rule A in step 22. In addition, the six pages associated with the individual rule A are bundled into one file in step 30 in accordance with the execution of collation of the twelfth page (P12) which is the final page, and then a file name “application ABCD_F2” having a file name prefix “application ABCD_”, associated with the individual rule A, added thereto is given to the original input file name (here, referred to as “F2”) in step 32. Then, an output file (output 7) given the file name “application ABCD_F2” is output using the rule A folder 501, which is set in the individual rule A, as an output destination in step 34. Thereafter, the output file (output 7) is stored in the rule A folder 501 which is provided in the image storage unit 500 of the server apparatus 5.

### Third Specific Example

FIG. 9 is a diagram showing a third specific example regarding the extraction and combination classifying process.

In the third specific example, a classification rule is a second overall rule R2 which is different from the first and second specific examples described above. Accordingly, individual rules to be set are two of an individual rule B and an individual rule C. Here, an output destination in the individual rule B is set to a “rule B folder”, and reference images are set to an “approval document”, an “application A”, and an “application B”. On the other hand, an output destination in the individual rule C is set to “rule C folder”, and reference images are set to an “application C” and an “application D”.

In addition, in the third specific example, an input file is the third input file F3. The third input file F3 includes pieces of target image data of a total of twelve pages including slips of seven pages (also see FIG. 5C).

In this manner, the first and second specific examples are different from the third specific example in a classification rule and contents of an input file to be processed.

Then, a description will be given of a classification result in a case where a process is performed on the third input file F3 in a state where the second overall rule R2 is set, according to the flow chart shown in FIG. 6.

In this case, an attached document 1 of a first page (P1), an attached document 2 of a fourth page (P4), an attached document 3 of a fifth page (P5), an attached document 4 of a ninth page (P9), and an attached document 5 of a twelfth page (P12), which are not slips, are determined to be negative (NO) in step 20, and thus the attached documents are sequentially output as individual output files in step 24. However, the five output files (an output 1 to an output 5) do not include a slip, and thus the output destinations thereof are not set to the rule B folder 502 which is set in the individual rule B or the rule C folder 503 which is set in an individual rule C, but are set to the out-of-rule folder 507. In addition, the five output files (the output 1 to the output 5) are stored in the out-of-rule folder 507 which is provided in the image storage unit 500 of the server apparatus 5.

On the other hand, an approval document 1 of a second page (P2), an application A1 of a third page (P3), an approval document 2 of a sixth page (P6), an application B1 of a seventh page (P7), an application C1 of an eighth page (P8), an application D1 of a tenth page (P10), and an approval document 3 of an eleventh page (P11), which are slips, are determined to be affirmative (YES) in step 20, and thus the approval documents and the applications are stored in the temporary storage region 55b in step 22. However, in this example, the approval document 1, the application A1, the approval document 2, the application B1, and the approval document 3 that conform to the individual rule B are stored in the temporary storage region 55b in a state of being associated with the individual rule B. On the other hand, in this example, the application C1 and the application D1 that conform to the individual rule C are stored in the temporary storage region 55b in a state of being associated with the individual rule C.

In addition, when a determination result in step 26 is affirmative (YES) in accordance with the execution of collation of the twelfth page (P12) which is the final page, the five pages associated with the individual rule B are bundled into one file in step 30, and then a file name “application AB_F3” having a file name prefix “application AB_”, associated with the individual rule B, added thereto is given to the original input file name (here, referred to as “F3”) in step 32. In addition, an output file (output 6) given the file name “application AB_F3” is output using the rule B folder 502, which is set in the individual rule B, as an output destination in step 34. Thereafter, the output file (output 6) is stored in the rule B folder 502 which is provided in the image storage unit 500 of the server apparatus 5.

In addition, the two pages associated with the individual rule C are bundled into one file in step 30, and then a file name “application CD_F3” having a file name prefix “application CD_”, associated with the individual rule C, added thereto is given to the original input file name (here, referred to as “F3”) in step 32. In addition, an output file (output 7) given the file name “application CD_F3” is output using the rule C folder 503, which is set in the individual rule C, as an output destination in step 34. Thereafter, the output file (output 7) is stored in the rule C folder 503 which is provided in the image storage unit 500 of the server apparatus 5.

Procedure of Continuous Combination Classifying Process

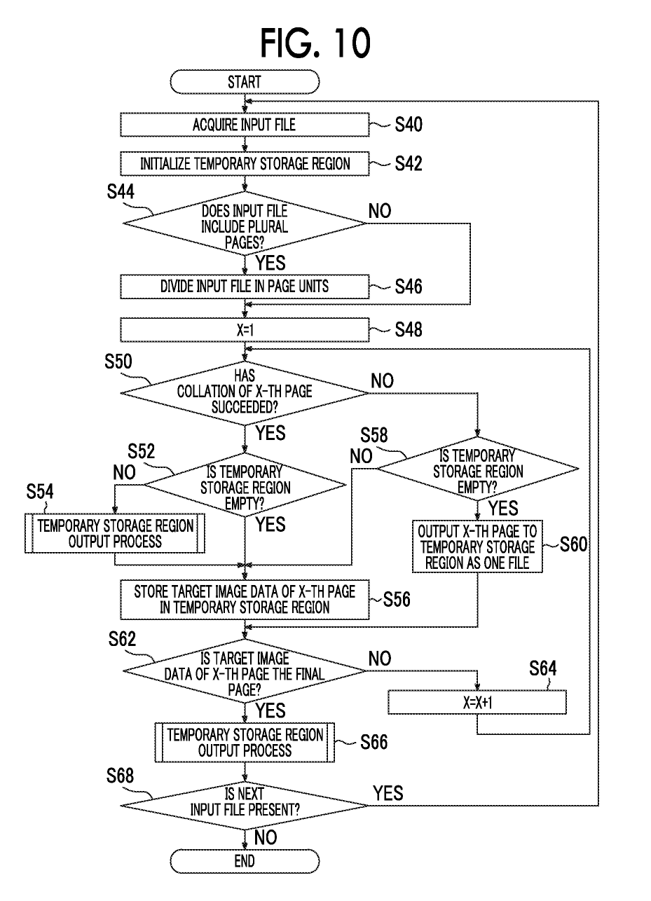

FIG. 10 is a flow chart showing a procedure of a continuous combination classifying process.

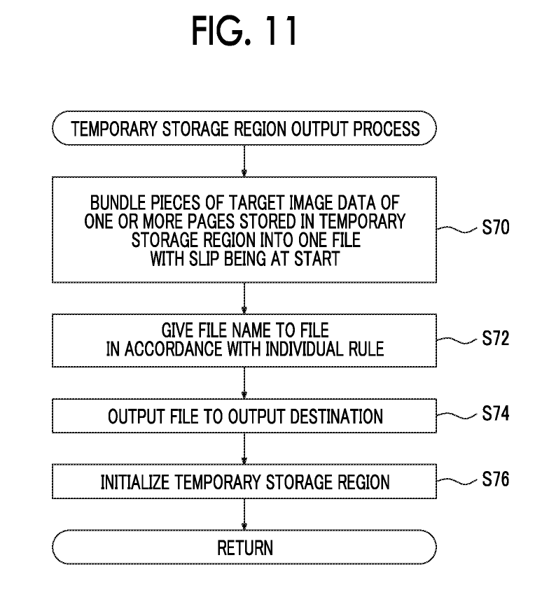

In this exemplary embodiment, a process shown in FIG. 10 (and FIG. 11 to be described later) is performed by the control unit 50 (CPU) which is provided in the image forming apparatus 1. Meanwhile, here, in the control unit 50 of the image forming apparatus 1, it is assumed that an overall rule (the third overall rule R3 or the fourth overall rule R4 shown in FIG. 3) which includes the execution of a continuous combination classifying process is read out from the rule storage region 55a of the storage unit 55 in advance and is set.

In this process, first, the division unit 52 acquires an input file through the input and output unit 51 (step 40). Then, the division unit 52 initializes the temporary storage region 55b which is provided in the storage unit 55 (step 42).

Next, the division unit 52 determines whether or not an input file acquired in step 40 includes plural pages (step 44). In a case where a determination result in step 44 is affirmative (YES), the division unit 52 divides the input file in page units (step 46), and outputs the divided input file to the collation unit 53, and the process proceeds to the next step 48. On the other hand, in a case where a determination result in step 44 is negative (NO), the division unit 52 outputs the input file to the collation unit 53 as it is without performing division, and the process proceeds to the next step 48.

Subsequently, the collation unit 53 sets a page number X to 1 (step 48) and collates target image data of an X-th page in the input file with one or more pieces of reference image data associated with an overall rule. In addition, it is determined whether or not the collation of the X-th page has succeeded (whether or not reference images having the same target image and form of the X-th page are present in the input file) (step 50).

In a case where a determination result in step 50 is affirmative (YES) (in a case where the X-th page is a conforming page), the collation unit 53 determines whether or not the temporary storage region 55b provided in the storage unit 55 is empty (whether or not there is target image data (page) which is stored already) (step 52). In a case where a determination result in step 52 is negative (NO), the reconstruction unit 54 performs a temporary storage region output process which is a subroutine (step 54), and clears the temporary storage region 55b, and the process proceeds to the next step 56. On the other hand, in a case where a determination result in step 52 is affirmative (YES), the process proceeds to the next step 56 as it is. Meanwhile, the temporary storage region output process shown in step 54 will be described later in detail.

Next, the collation unit 53 stores the target image data of the X-th page in the temporary storage region 55b (step 56), and the process proceeds to the next step 62.

On the other hand, in a case where a determination result in step 50 mentioned above is negative (NO) (in a case where the X-th page is a non-conforming page), the collation unit 53 determines whether or not the temporary storage region 55b provided in the storage unit 55 is empty (step 58). In a case where a determination result in step 58 is negative (NO), the process proceeds to step 56 mentioned above, and the collation unit 53 stores the target image data of the X-th page in the temporary storage region 55b and the process proceeds to the next step 62. On the other hand, in a case where a determination result in step 58 is affirmative (YES), the collation unit 53 outputs the target image data of the X-th page to the reconstruction unit 54. The reconstruction unit 54 reconstructs the target image data of the X-th page into one file, and outputs the reconstructed data to an output destination associated with an individual rule (step 60), and the process proceeds to the next step 62. Meanwhile, in step 60, the reconstruction unit 54 outputs the obtained file to the outside (here, the transmission and reception unit 40) through the input and output unit 51, as an output file. In addition, the output file is transmitted to the server apparatus 5 through the network 2, and is stored in the out-of-rule folder 507 which is provided in the image storage unit 500 of the server apparatus 5.

Subsequently, the collation unit 53 determines whether or not the target image data of the X-th page is the final page in the input file (step 62). In a case where a determination result in step 62 is negative (NO), the collation unit 53 updates a page number to X=X+1 (step 64), and returns to step 50 to continue a process related to target image data of the next page.

On the other hand, in a case where a determination result in step 62 is affirmative (YES), the reconstruction unit 54 performs a temporary storage region output process which is a subroutine (step 66), and clears the temporary storage region 55b, and the process proceeds to the next step 68. Meanwhile, the temporary storage region output process shown in step 66 has the same contents of that performed in step 54 mentioned above.

Thereafter, the division unit 52 determines whether or not the next input file is present (step 68). In a case where a determination result in step 68 is affirmative (YES), the division unit 52 returns to step 40 and continues a process with respect to the next input file. On the other hand, in a case where a determination result in step 68 is negative (NO), the process is terminated.

FIG. 11 is a flow chart showing a procedure of a temporary storage region output process (subroutine) shown in FIG. 10. The temporary storage region output process is performed in each of step 54 and step 66 that are shown in FIG. 10.

In this process, first, the reconstruction unit 54 the reconstruction unit 54 bundles pieces of target image data of one or more pages stored in the temporary storage region 55b of the storage unit 55 into one file with a slip being at a start and stores the bundled file (step 70). That is, in the step 70, one file is necessarily created. In addition, in step 70, in a case where pieces of target image data for only one page are stored in the temporary storage region 55b, a file including the pieces of target image data for one page is created.

Then, the reconstruction unit 54 gives a file name, obtained by adding a file name prefix associated with an individual rule to a file name of the original input file of the file, to one file created in step 70 (step 72).

In addition, the reconstruction unit 54 outputs one file given the file name in step 72 to the outside (here, the transmission and reception unit 40) through the input and output unit 51, as an output file (step 74). In addition, the output file is transmitted to the server apparatus 5 through the network 2, and is stored in a folder (in this example, any one of the rule D folder 504 to the rule F folder 506 in a case of a continuous combination classifying process) other than the out-of-rule folder 507 which is provided in the image storage unit 500 of the server apparatus 5.

Thereafter, the reconstruction unit 54 initializes the temporary storage region 55b which is provided in the storage unit 55 (step 76), and returns to a main routine of the continuous combination classifying process shown in FIG. 10.

### Specific Example of Continuous Combination Classifying Process

Next, the above-described continuous combination classifying process will be described with reference to two specific examples.

### First Specific Example

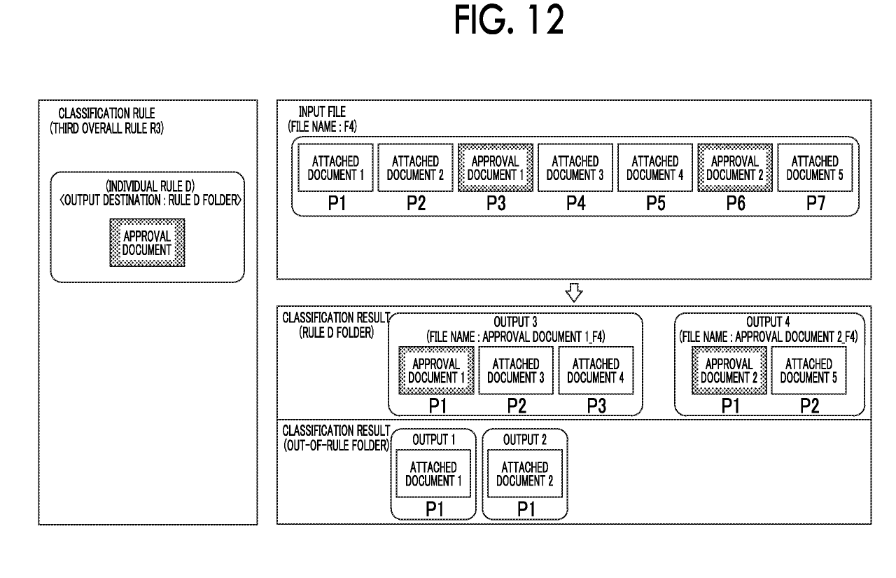

FIG. 12 is a diagram showing a first specific example regarding the continuous combination classifying process.

In the first specific example, a classification rule is a third overall rule R3. Accordingly, an individual rule to be set is only an individual rule D, an output destination is set to a “rule D folder”, and a reference image is set to an “approval document”.

In addition, in the first specific example, an input file is the fourth input file F4. The fourth input file F4 includes pieces of target image data of a total of seven pages including slips of two pages (an approval document 1 and an approval document 2) (also see FIG. 5D).

Then, a description will be given of a classification result in a case where a process is performed on the fourth input file F4 in a state where the third overall rule R3 is set, according to the flow charts shown in FIGS. 10 and 11.

In this case, first, an attached document 1 of a first page (P1) and an attached document 2 of a second page (P2), which are not slips, are determined to be negative (NO) in step 50 and are then determined to be affirmative (YES) in step 58, and thus the attached documents are sequentially output as individual output files in step 60. However, the two output files (an output 1 and an output 2) do not include a slip, and thus the output destinations thereof are not set to the rule D folder 504 which is set in the individual rule D, but are set to the out-of-rule folder 507. In addition, the two output files (the output 1 and the output 2) are stored in the out-of-rule folder 507 which is provided in the image storage unit 500 of the server apparatus 5.

In addition, an approval document 1 of a third page (P3), which is a slip, is determined to be affirmative (YES) in step 50 and is then determined to be affirmative (YES) in step 52, and thus the approval document is stored in the temporary storage region 55b in step 56. Next, an attached document 3 of a fourth page (P4) and an attached document 4 of a fifth page (P5), which are not slips, are determined to be negative (NO) in step 50 and are then determined to be negative (NO) in step 58, and thus the attached documents are stored in the temporary storage region 55b together with the approval document 1 of the third page (P3) mentioned above, in step 56.

Further, an approval document 2 of a sixth page (P6), which is a slip, is determined to be affirmative (YES) in step 50 and is then determined to be negative (NO) in step 52. Accordingly, the temporary storage region output process (subroutine) shown in step 54 is performed, and three pages (the approval document 1, the attached document 3, and the attached document 4) which are stored in the temporary storage region 55b are bundled into one file with the approval document 1 as the first page in step 70. Then, a file name “approval document 1_F4” having a file name prefix “approval document 1_”, associated with the individual rule D, added thereto is given to the original input file name (here, referred to as “F4”) in step 72. In addition, an output file (output 3) given the file name “approval document 1_F4” is output using the rule D folder 504, which is set in the individual rule D, as an output destination in step 74. Thereafter, the output file (output 3) is stored in the rule D folder 504 which is provided in the image storage unit 500 of the server apparatus 5. In addition, after the output file (output 3) is output, the temporary storage region 55b is initialized in step 76, and the process of step 54 is completed.

Then, the approval document 2 of the sixth page (P6), which is a slip, is stored in the temporary storage region 55b in step 56. Next, an attached document 5 of a seventh page (P7), which is not a slip, is determined to be negative (NO) in step 50 and is then determined to be negative (NO) in step 58, and thus the attached document is stored in the temporary storage region 55b together with the approval document 2 of the sixth page (P6) mentioned above, in step 56.

In addition, a determination result in step 62 is affirmative (YES) in accordance with the execution of collation of the seventh page (P7) which is the final page. Accordingly, the temporary storage region output process (subroutine) shown in step 66 is performed, and two pages (the approval document 2 and the attached document 5) which are stored in the temporary storage region 55b are bundled into one file with the approval document 2 as the first page in step 70. Then, a file name “approval document 2_F4” having a file name prefix “approval document 2_”, associated with the individual rule D, added thereto is given to the original input filename (here, referred to as “F4”) in step 72. In addition, an output file (output 4) given the file name “approval document 2_F4” is output using the rule D folder 504, which is set in the individual rule D, as an output destination in step 74. Thereafter, the output file (output 4) is stored in the rule D folder 504 which is provided in the image storage unit 500 of the server apparatus 5. In addition, after the output file (output 4) is output, the temporary storage region 55b is initialized in step 76, and the process of step 66 is completed.

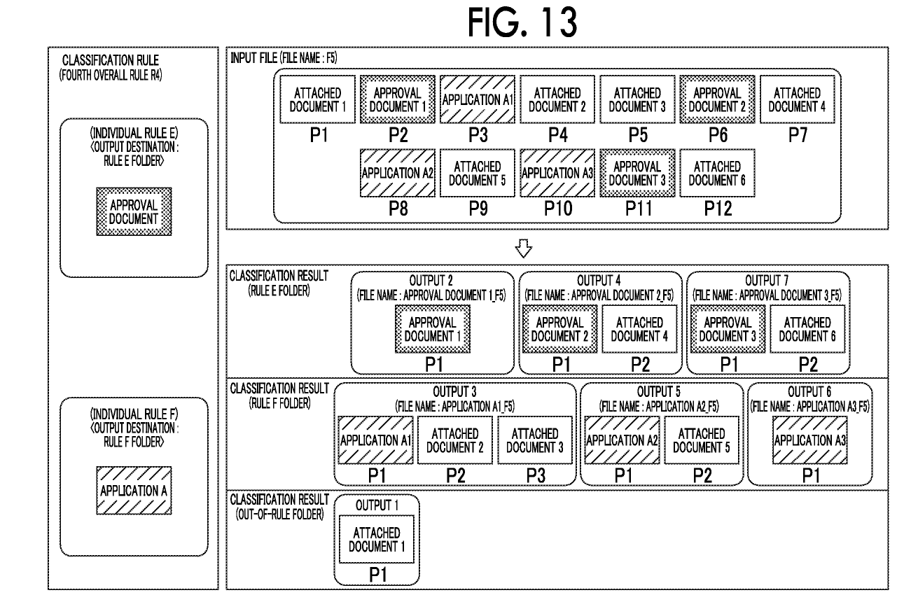

Meanwhile, when one file is created by bundling plural pages in step 70 in the temporary storage region output process shown in step 54 and step 66, the order of pages in a new file (output file) may match to the order of pages in the original input file (page numbers in the input file may be aligned in ascending order). Meanwhile, this is the same as in a second specific example shown in FIG. 13 to be described later.

### Second Specific Example

FIG. 13 is a diagram showing a second specific example regarding the continuous combination classifying process.

In the second specific example, a classification rule is a fourth overall rule R4. Accordingly, an individual rule to be set is two of an individual rule E and an individual rule F. Here, an output destination in the individual rule E is set to a “rule E folder”, and a reference image is set to an “approval document”. On the other hand, an output destination in the individual rule F is set to a “rule F folder”, and a reference image is set to an “application A”.

In addition, in the second specific example, an input file is a fifth input file F5. The fifth input file F5 includes pieces of target image data of a total of twelve pages including slips of six pages (also see FIG. 5E).

In this manner, the first specific example and the second specific example are different from each other in a classification rule and contents of an input file to be processed.

Then, a description will be given of a classification result in a case where a process is performed on the fifth input file F5 in a state where the fourth overall rule R4 is set, according to the flow charts shown in FIGS. 10 and 11.

In this case, first, an attached document 1 of a first page (P1), which is not a slip, is determined to be negative (NO) in step 50 and is then determined to be affirmative (YES) in step 58, and thus the attached document is output as one output file (output 1) in step 60. However, the output file (output 1) does not include a slip, and thus the output destination thereof is not set to the rule E folder 505 which is set in the individual rule E and the rule F folder 506 which is set in the individual rule F, but is set to the out-of-rule folder 507. In addition, the output file (output 1) is stored in the out-of-rule folder 507 which is provided in the image storage unit 500 of the server apparatus 5.

In addition, an approval document 1 of a second page (P2), which is a slip, is determined to be affirmative (YES) in step 50 and is then determined to be affirmative (YES) in step 52, and thus the approval document is stored in the temporary storage region 55b in step 56.

Further, an application A1 of a third page (P3), which is a slip, is determined to be affirmative (YES) in step 50 and is then determined to be negative (NO) in step 52. Accordingly, the temporary storage region output process (subroutine) shown in step 54 is performed, and one page (approval document 1) which is stored in the temporary storage region 55b is bundled into one file in step 70. Then, a file name “approval document 1_F5” having a file name prefix “approval document 1_”, associated with the individual rule E, added thereto is given to the original input file name (here, referred to as “F5”) in step 72. In addition, an output file (output 2) given the file name “approval document 1_F5” is output using the rule E folder 505, which is set in the individual rule E, as an output destination in step 74. Thereafter, the output file (output 2) is stored in the rule E folder 505 which is provided in the image storage unit 500 of the server apparatus 5. In addition, after the output file (output 2) is output, the temporary storage region 55b is initialized in step 76, and the process of step 54 is completed.

Then, the application A1 of the third page (P3), which is a slip, is stored in the temporary storage region 55b in step 56. Next, an attached document 2 of a fourth page (P4) and an attached document 3 of a fifth page (P5), which are not slips, are determined to be negative (NO) in step 50 and are then determined to be negative (NO) in step 58, and thus the attached documents are stored in the temporary storage region 55b together with the application A1 of the third page (P3) mentioned above, in step 56.

Further, an approval document 2 of a sixth page (P6), which is a slip, is determined to be affirmative (YES) in step 50 and is then determined to be negative (NO) in step 52. Accordingly, the temporary storage region output process (subroutine) shown in step 54 is performed, and three pages (the application A1, the attached document 2, and the attached document 3) which are stored in the temporary storage region 55b are bundled into one file with the application A1 as the first page in step 70. Then, a file name “application A1_F5” having a file name prefix “application A1_”, associated with the individual rule F, added thereto is given to the original input file name (here, referred to as “F5”) in step 72. In addition, an output file (output 3) given the file name “application A1_F5” is output using the rule F folder 506, which is set in the individual rule F, as an output destination in step 74. Thereafter, the output file (output 3) is stored in the rule F folder 506 which is provided in the image storage unit 500 of the server apparatus 5. In addition, after the output file (output 3) is output, the temporary storage region 55b is initialized in step 76, and the process of step 54 is completed.

Then, the approval document 2 of the sixth page (P6), which is a slip, is stored in the temporary storage region 55b in step 56. Next, an attached document 4 of a seventh page (P7), which is not a slip, is determined to be negative (NO) in step 50 and is then determined to be negative (NO) in step 58, and thus the attached document is stored in the temporary storage region 55b together with the approval document 2 of the sixth page (P6) mentioned above, in step 56.

Further, an application A2 of an eighth page (P8), which is a slip, is determined to be affirmative (YES) in step 50 and is then determined to be negative (NO) in step 52. Accordingly, the temporary storage region output process (subroutine) shown in step 54 is performed, and two pages (the approval document 2 and the attached document 4) which are stored in the temporary storage region 55b are bundled into one file with the approval document 2 as the first page in step 70. Then, a file name “approval document 2_F5” having a file name prefix “approval document 2_”, associated with the individual rule E, added thereto is given to the original input file name (here, referred to as “F5”) in step 72. In addition, an output file (output 4) given the file name “approval document 2_F5” is output using the rule E folder 505, which is set in the individual rule E, as an output destination in step 74. Thereafter, the output file (output 4) is stored in the rule E folder 505 which is provided in the image storage unit 500 of the server apparatus 5. In addition, after the output file (output 4) is output, the temporary storage region 55b is initialized in step 76, and the process of step 54 is completed.

Then, the application A2 of the eighth page (P8), which is a slip, is stored in the temporary storage region 55b in step 56. Next, an attached document 5 of a ninth page (P9), which is not a slip, is determined to be negative (NO) in step 50 and is then determined to be negative (NO) in step 58, and thus the attached document is stored in the temporary storage region 55b together with the application A2 of the eighth page (P8) mentioned above, in step 56.

In addition, an application A3 of a tenth page (P10), which is a slip, is determined to be affirmative (YES) in step 50 and is then determined to be negative (NO) in step 52. Accordingly, the temporary storage region output process (subroutine) shown in step 54 is performed, and two pages (the application A2 and the attached document 5) which are stored in the temporary storage region 55b are bundled into one file with the application A2 as the first page in step 70. Then, a file name “application A2_F5” having a file name prefix “application A2_”, associated with the individual rule F, added thereto is given to the original input filename (here, referred to as “F5”) in step 72. In addition, an output file (output 5) given the file name “application A2_F5” is output using the rule F folder 506, which is set in the individual rule F, as an output destination in step 74. Thereafter, the output file (output 5) is stored in the rule F folder 506 which is provided in the image storage unit 500 of the server apparatus 5. In addition, after the output file (output 5) is output, the temporary storage region 55b is initialized in step 76, and the process of step 54 is completed.

Then, the application A3 of the tenth page (P10), which is a slip, is stored in the temporary storage region 55b in step 56.

Further, an approval document 3 of an eleventh page (P11), which is a slip, is determined to be affirmative (YES) in step 50 and is then determined to be negative (NO) in step 52. Accordingly, the temporary storage region output process (subroutine) shown in step 54 is performed, and one page (the application A3) which is stored in the temporary storage region 55b is configured as one file in step 70. Then, a file name “application A3_F5” having a file name prefix “application A3_”, associated with the individual rule F, added thereto is given to the original input file name (here, referred to as “F5”) in step 72. In addition, an output file (output 6) given the file name “application A3_F5” is output using the rule F folder 506, which is set in the individual rule F, as an output destination in step 74. Thereafter, the output file (output 6) is stored in the rule F folder 506 which is provided in the image storage unit 500 of the server apparatus 5. In addition, after the output file (output 6) is output, the temporary storage region 55b is initialized in step 76, and the process of step 54 is completed.

Then, the approval document 3 of the eleventh page (P11), which is a slip, is stored in the temporary storage region 55b in step 56. Next, an attached document 6 of a twelfth page (P12), which is not a slip, is determined to be negative (NO) in step 50 and is then determined to be negative (NO) in step 58, and thus the attached document is stored in the temporary storage region 55b together with the approval document 3 of the eleventh page (P11) mentioned above, in step 56.

In addition, a determination result in step 62 is affirmative (YES) in accordance with the execution of collation of the twelfth page (P12) which is the final page. Accordingly, the temporary storage region output process (subroutine) shown in step 66 is performed, and two pages (the approval document 3 and the attached document 6) which are stored in the temporary storage region 55b are bundled into one file with the approval document 3 as the first page in step 70. Then, a file name “approval document 3_F5” having a file name prefix “approval document 3_”, associated with the individual rule E, added thereto is given to the original input filename (here, referred to as “F5”) in step 72. In addition, an output file (output 7) given the file name “approval document 3_F5” is output using the rule E folder 505, which is set in the individual rule E, as an output destination in step 74. Thereafter, the output file (output 7) is stored in the rule E folder 505 which is provided in the image storage unit 500 of the server apparatus 5. In addition, after the output file (output 7) is output, the temporary storage region 55b is initialized in step 76, and the process of step 66 is completed.

### Modification Example of Continuous Combination Classifying Process

In the above-described continuous combination classifying process, a page of a slip extracted from an input file and pages of one or more attached documents continuous with the page of the slip in the input file are configured as a bundle of output files, but the invention is not limited thereto. For example, a configuration may be adopted in which the number of one or more pages (referred to as a set number of pages) is set in advance, and a page of a slip extracted from an input file and the above-mentioned set number of pages continuous with the page of the slip are configured as a bundle of output files. In this case, for example, when a set number of pages is set to 2, an output file including a slip necessarily includes a slip for one page and accessory documents (not limited to attached documents) for two pages continuous with the page of the slip.

Others

Meanwhile, in this exemplary embodiment, an output file obtained by reconstructing an input file is stored in the image storage unit 500 which is provided in the server apparatus 5, but the invention is not limited thereto. For example, an output destination of the output file may be the terminal apparatus 3 or any of other apparatuses. In addition, in this exemplary embodiment, although an output file obtained by reconstructing an input file is stored in plural folders which are provided in the image storage unit 500 of the server apparatus 5, the invention is not limited thereto, and the folders may be provided in different storage apparatuses.

Further, in this exemplary embodiment, an output file obtained by reconstructing an input file is output as data, but the invention is not limited thereto. For example, one or more pages (image data) which constitute the output file may be printed on a sheet using the image forming unit 20, may be transmitted to the terminal apparatus 3 or the like in a state of being attached to an e-mail, or may be used to start up a specific program (application) which is associated with the output file.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A file reconstruction device comprising:
an extraction unit that extracts pages conforming to a predetermined condition, from an input file including a plurality of pages; and
a creation unit that creates an output file including the two or more conforming pages extracted from the input file by the extraction unit.

2. The file reconstruction device according to claim 1, further comprising:
a collation unit that collates images of the respective pages in the input file with a reference image which is determined as the condition in advance,
wherein the extraction unit extracts, as the conforming page, a page having succeeded in collation with the reference image, which is performed by the collation unit, from the input file.

3. The file reconstruction device according to claim 2,
wherein in a case where the reference image in the condition includes a first reference image and a second reference image, the creation unit creates the output file including
one or more conforming pages having succeeded in collation with the first reference image, which is performed by the collation unit, in the input file, and
one or more conforming pages having succeeded in collation with the second reference image, which is performed by the collation unit, in the input file.

4. The file reconstruction device according to claim 3, wherein in a case where the condition includes a first condition including one of the first and second reference images as the reference image and a second condition including the other of the first and second reference images as the reference image, the creation unit creates, as the output file, a first output file including two or more pages having succeeded in collation with the first reference images, which is performed by the collation unit, in the input file, and a second output file including two or more pages having succeeded in collation with the second reference images, which is performed by the collation unit, in the input file.

5. A file reconstruction device comprising:
an extraction unit that extracts a page conforming a predetermined condition, from an input file including a plurality of pages; and
a creation unit that creates an output file including
the single conforming page which is extracted from the input file by the extraction unit, and
one or more non-conforming pages which are continuous with the conforming page in the input file and which are not extracted from the input file by the extraction unit due to not conforming to the condition.

6. The file reconstruction device according to claim 5, further comprising:
a collation unit that collates images of the respective pages in the input file with a reference image which is determined as the condition in advance,
wherein the extraction unit extracts, as the conforming pages, pages having succeeded in collation with the reference image, which is performed by the collation unit, from the input file.

7. A file reconstruction device comprising:
an extraction unit that extracts a page conforming to a predetermined condition and a predetermined number of continuous pages which are continuous with the conforming page, from an input file including a plurality of pages; and
a creation unit that creates an output file including the single conforming page and the one or more continuous pages which are extracted from the input file by the extraction unit.

8. The file reconstruction device according to claim 7, further comprising:
a collation unit that collates images of the respective pages in the input file with a reference image which is determined as the condition in advance,
wherein the extraction unit extracts, as the conforming pages, pages having succeeded in collation with the reference image, which is performed by the collation unit, from the input file.

9. A non-transitory computer readable storage medium storing a program that causes a computer to execute a file reconstruction process comprising:
extracting pages conforming to a predetermined condition, from an input file including a plurality of pages; and
creating an output file including the two or more conforming pages extracted from the input file.

10. A non-transitory computer readable storage medium storing a program that causes a computer to execute a file reconstruction process comprising:
extracting a page conforming a predetermined condition, from an input file including a plurality of pages; and
creating an output file including
the single conforming page extracted from the input file, and
one or more non-conforming pages which are continuous with the conforming page in the input file and which are not extracted from the input file due to not conforming to the condition.

11. A non-transitory computer readable storage medium storing a program that causes a computer to execute a file reconstruction process comprising:
extracting a page conforming to a predetermined condition and a predetermined number of continuous pages which are continuous with the conforming page, from an input file including a plurality of pages; and
creating an output file including the single conforming page and the one or more continuous pages which are extracted from the input file.
